(19) United States
(12) Patent Application Publication
(10) Pub. No.: US 2018/0364277 A1
(43) Pub. Date: Dec. 20, 2018

(54) A METHOD TO MEASURE NANOSCALE MECHANICAL PROPERTIES USING ATOMIC FORCE MICROSCOPY WITHOUT INITIALLY CHARACTERIZING CANTILEVER TIP GEOMETRY

(71) Applicants: Sean Andrew Cantrell, Williamsburg, VA (US); Sean Murdock, Glencoe, IL (US)

(72) Inventors: Sean Andrew Cantrell, Williamsburg, VA (US); Sean Murdock, Glencoe, IL (US)

(21) Appl. No.: 16/060,435

(22) PCT Filed: Dec. 8, 2016
(86) PCT No.: PCT/US16/65673

§ 371 Date: Jun. 8, 2018

Related U.S. Application Data
(60) Provisional application No. 62/264,396, filed on Dec. 8, 2015.

(51) Int. Cl. G01Q 30/06; G01Q 10/06; G01Q 60/28; G01B 5/28; G01Q 20/00

(52) U.S. Cl. CPC G01Q 30/06; G01Q 10/06; G01Q 20/00; G01B 5/28; G01Q 60/28

(57) ABSTRACT

The atomic force microscope has evolved from purely a qualitative apparatus that measures the topography of a sample into a quantitative tool that also measures mechanical properties of a sample at the nanoscale. Prior technologies that attempt to measure the bulk parameters must characterize the geometry of the atomic force microscope cantilever tip in a separate experiment before being able to measure the mechanical properties of the sample. This is the single biggest obstruction to the accuracy and expediency of quantitative atomic force microscopy methodologies. Present techniques are also unable to probe the full set of viscoelastic properties of a material as they do not include any method to measure the damping of samples. We propose a method herein that simultaneously circumvents the need for a separate experiment to characterize the tip geometry and measures the full set of viscoelastic properties of a material.

### CROSS REFERENCE

This application claims the benefit of U.S. Provisional Application No. 62/084,032, filed Dec. 8, 2015, the subject matter of which is expressly incorporated by reference.

### TECHNICAL FIELD

The scope includes a method for measuring the bulk mechanical properties of a material.

### BACKGROUND ART

Scanning probe microscopy (SPM) is a branch of microscopy that forms images of surfaces of a sample or specimen using a physical probe that scans the sample. An image of the surface is obtained by mechanically moving the probe in a raster (line by line) scan of the sample and recording the interaction between the probe and the sample surface as a function of the position of the probe relative to the surface of the sample. An atomic force microscope (AFM) is a type of SPM that employs a cantilever with an atomically sharp tip at the end as the probe. Referring now to FIG. 1, a prior art AFM is illustrated. The AFM of FIG. 1 comprises a controller 12, a microscale cantilever 14 with a sharp tip (probe) at one end that is used to scan the surface of the sample 18, a laser 20, a photo-diode 22 (while the term photo-diode is used herein, an array of photo-diodes is typically used), and an image processor 24. When the probe tip is brought into proximity of the sample surface, forces between the tip and the sample cause a deflection of the cantilever, and this deflection may be measured using the laser and photo-diode. A laser spot (illustrated by line 28) is reflected (illustrated by line 30) by the top of the cantilever onto the photo-diode, and the resulting electrical signal (illustrated by line 32) is sent to the controller 12. The deflection of the cantilever causes an amplitude change in the reflected laser spot (and in the resulting electrical signal), such that the amplitude at any specific time corresponds to the surface contour of the sample at a specific location on the sample. As this scanning is performed over the entire surface of the sample, the resulting amplitude data corresponds to the surface contour of the entire sample. The location and amplitude data is provided to the image processor (illustrated by line 34), such that the image processor is able to create an image of the surface of the sample.

There are two primary modes in which the AFM is operated: static and dynamic modes. In static modes, the cantilever is brought into contact with the sample, and its deflection directly represents the topography of the probed sample. In dynamic modes, the cantilever is driven at user-specified frequencies and amplitudes by a piezo stack at its base and the amplitude and phase of the resulting oscillation is directly measured. Topography and, in principle, mechanical properties of the sample can be determined using these methods. The mechanical properties such as the (reduced) Young's modulus are of particular modern interest, and efforts to develop quantitative techniques measure them using the AFM has comprised much of the research in atomic force microscopy. All current methods assume the sample surface is quasi-static, and most drive the cantilever at a single frequency and directly measure an effective stiffness of the sample that must be further resolved. The effective stiffness is a function of the contact radius between the cantilever tip and the sample. A separate experiment is typically conducted to characterize the tip geometry, which is typically assumed to be hemi-spherical, using a calibrated sample. Using this information, the contact area in the experiment of interest can be estimated, and the reduced Young's modulus can be extracted from the effective stiffness. Ignoring sample dynamics and assuming the sample is quasi-static precludes measuring the full set of viscoelastic parameters of a material and is also what forces a separate experiment to be conducted to characterize the tip geometry. It also leads to the erroneous conclusion that the sample stiffness is dependent on the driving frequency.

### SUMMARY

Previous work has been done to obtain the effective mechanical properties via harmonic amplitude spectrum atomic force microscopy (HAS-AFM) using generic peripheral equipment in the patent application 62/084,032. HAS-AFM drives the cantilever at a plurality of frequencies to measure effective damping and mass in addition to effective stiffness. These effective parameters also involve the contact area, but additionally include corrections to the usual quasi-static equations employed in most quantitative AFM techniques. In the proposed method herein, we leverage the HAS-AFM apparatus to obtain the cantilever response at a plurality of frequencies and fit a novel model of dynamic contact mechanics to determine (reduced) Young's modulus and bulk damping parameters.

Harmonic amplitude spectrum atomic force microscopy (HAS-AFM) is employed using a field programmable gate array (FPGA) peripheral device to send and receive signals from the signal access module (SAM) of a generic atomic force microscope (AFM) system. The FPGA delivers signals at a plurality of frequencies to the SAM to excite the AFM cantilever. The cantilever interacts with a material sample and generates signals at a plurality of frequencies and their harmonics. The response of the cantilever at the plurality of frequencies and their harmonics is received by and stored on the FPGA. Logic, detailed herein, is provided to determine the bulk mechanical properties of the sample from the recorded cantilever response. The logic uniquely utilizes sample dynamics in its measurement.

### BRIEF DESCRIPTION OF DRAWINGS

FIG. 1 illustrates a prior art atomic force microscope.

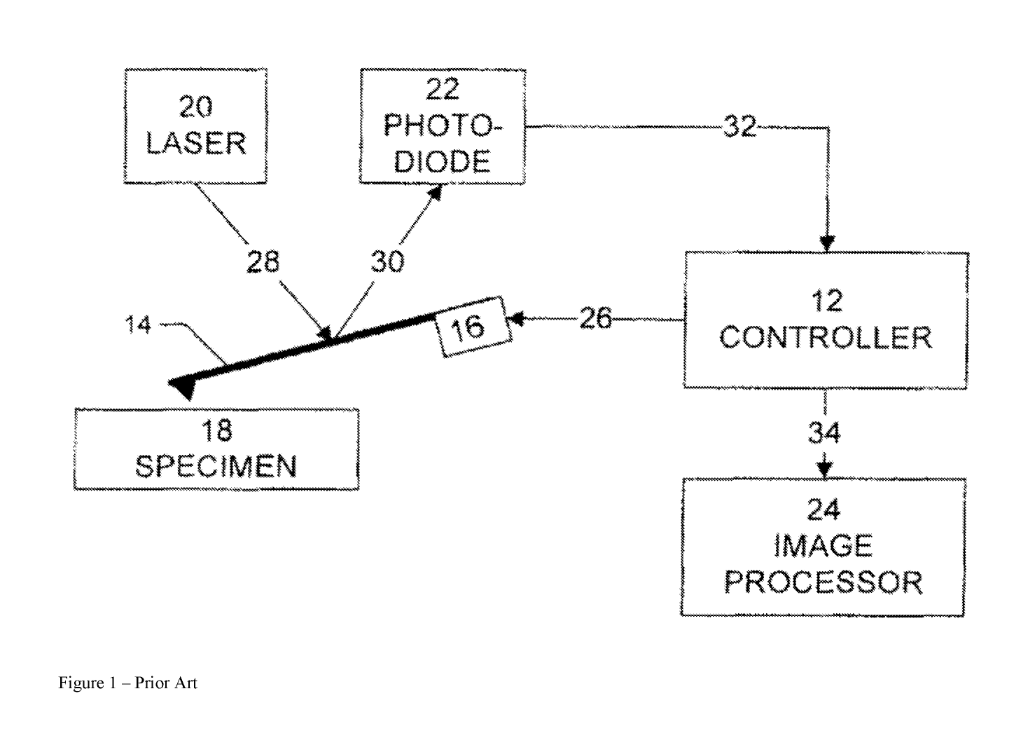

FIG. 2 illustrates the peripheral equipment and software the field programmable gate array (FPGA) delivery vector.

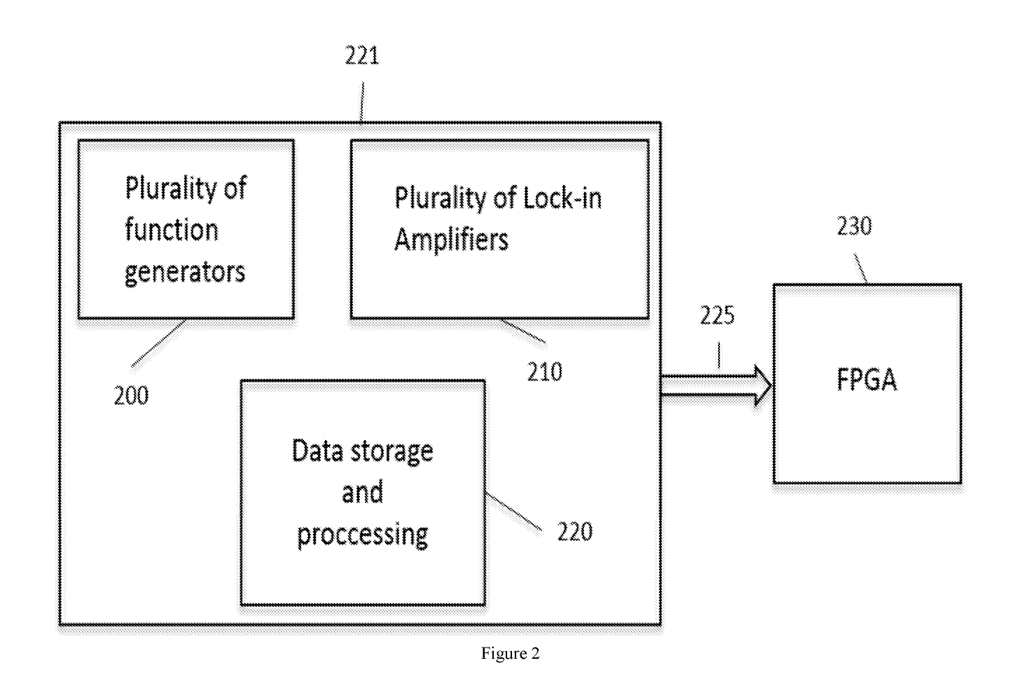

FIG. 3 illustrates the implementation of the harmonic amplitude spectrum atomic force microscopy (HAS-AFM) technology by interfacing with the AFM through the signal access module (SAM) with the FPGA delivery vector.

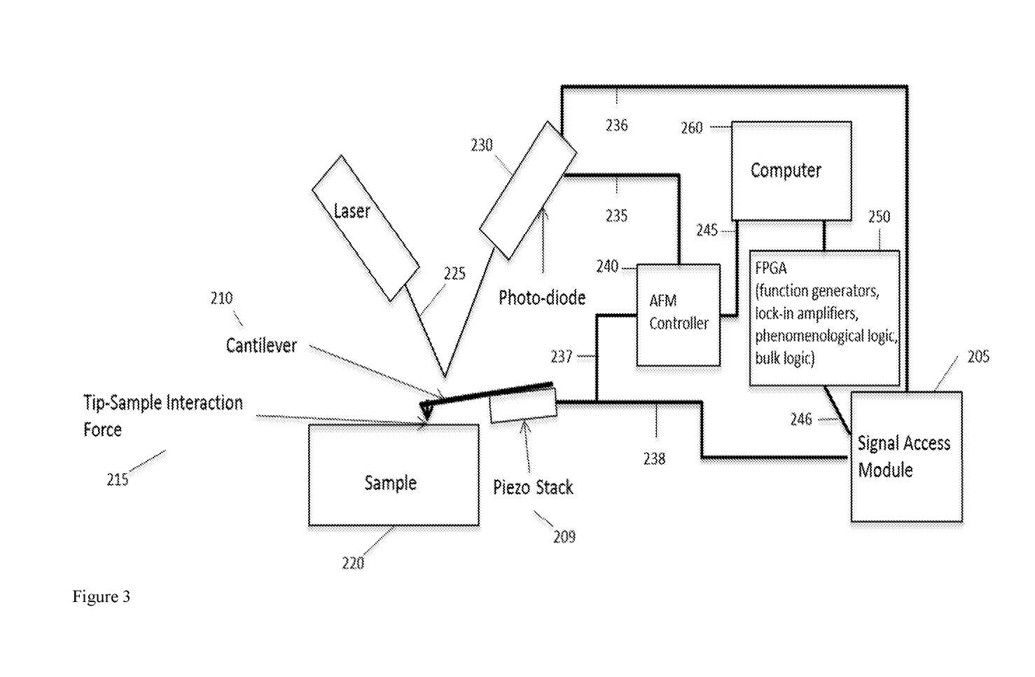

FIG. 4 illustrates an example of a pressure distribution at the upper boundary of a sample.

FIG. 5 illustrates the method of images employed to obtain the model of dynamic contact mechanics.

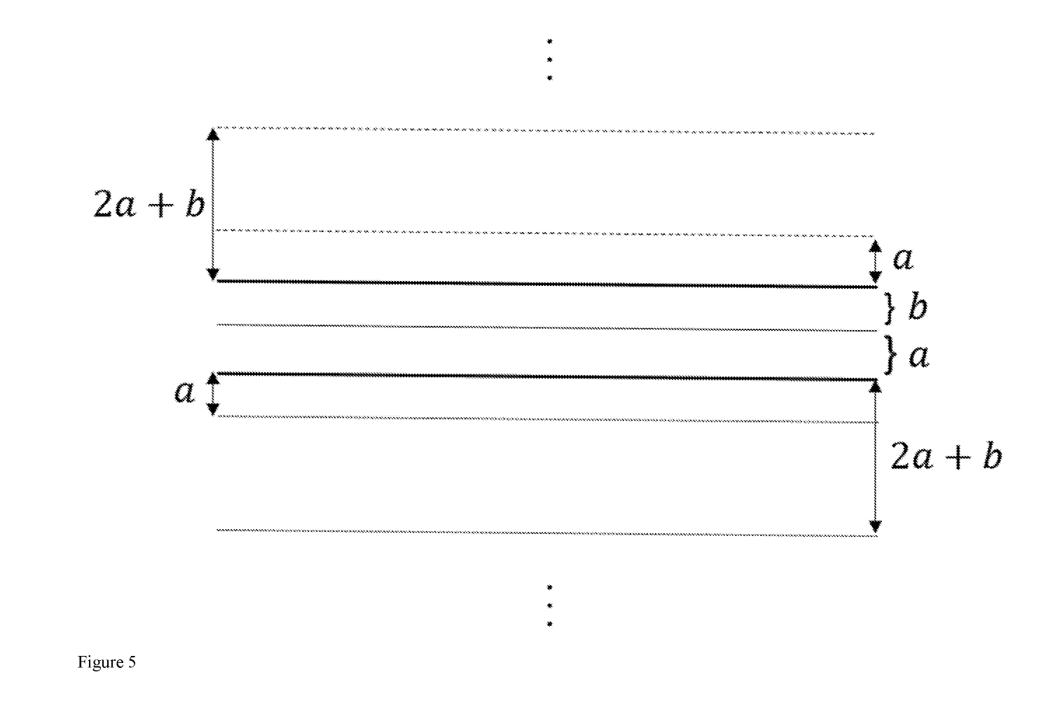

FIG. 6 depicts a chart illustrating the predicted fractional change in the magnitude of the sample Green function as a function of factor multiplied by cantilever fundamental frequency.

### DISCLOSURE OF INVENTION

The method to measure bulk mechanical properties of probed samples is enumerated as follows

A. Record cantilever response when in contact with a sample is obtained at a plurality of frequencies via HAS-AFM. This step is comprised of
1. Connecting a field programmable gate array (FPGA) to a signal access module (SAM) for an atomic force microscope
2. Driving the cantilever in free space at a plurality of frequencies and recording the response using logic on the FPGA
3. Characterizing the cantilever based on the recorded response
4. Engaging the sample surface with the cantilever tip
5. Driving at the plurality of frequencies while engaged and recording the cantilever response using logic on the FPGA
B. Utilize a novel model of dynamic contact mechanics to solve for bulk mechanical parameters of a sample using the cantilever response by
1. Choosing the parameters in the model that make the predicted motion of the model optimally fit the recorded response
2. Determining the contact area between the cantilever tip and sample from this fit
3. Extracting the reduced Young's modulus and damping parameters from the fit

Below, we detail the logic to determine material mechanical properties of the probed samples using the phenomenological parameters. To obtain the model of dynamic contact mechanics and extract a Green function to be employed in HAS-AFM, we must consider a novel model of dynamic contact mechanics that accounts, explicitly, for sample dynamics. We wish to solve the equation for wave propagation in a material of finite thickness and infinite lateral extent that is subjected to a local pressure distribution at its upper boundary, z=a, and held pinned at its lower boundary, z=0:

[ρδₘⁱ∂ₜ²−gₗₘ(C^{ijkl}+Γ^{ijkl}∂ₜ)∇ⱼ∇ₖ]u^{m}(t,z,\vec{x})=P^{ij}[η₁(t)+η₂(t)]\hat{n}ⱼδ(z−a) (1)

where u^{m} is the mth component of the displacement field at a point (z, \vec{x}) in the material, and where z is the coordinate running along the finite axis and \vec{x} parameterizes the position in the lateral plane. The unit vector \hat{n}ⱼ is normal to the surface, and thus dependent on ∇u(z=a).

Define the operator

E^{ijkl}≡C^{ijkl}+Γ^{ijkl}∂ₜ (2)

For an isotropic material, we have

$$\begin{matrix}{E}^{ijkl} = {E}^{klij} \\ = {E}^{jikl} \\ = {E}^{ijlk}\end{matrix}$$

$$and$$

$${E}_{1} = {C}_{1} + {Γ}_{1} {\partial }_{t} ≡ {E}^{1111} = {E}^{2222} = {E}^{3333}$$

$${E}_{2} = {C}_{2} + {Γ}_{2} {\partial }_{t} ≡ {E}^{1212} = {E}^{1313} = {E}^{2323}$$

$${E}_{3} = {C}_{3} + {Γ}_{3} {\partial }_{t} ≡ {E}^{1122} = {E}^{1133} = {E}^{2233} = {E}_{1} - 2 {E}_{2}$$

with all other components vanishing.

Under these symmetries, there are three equations of interest:

[ρ∂ₜ²−E₁∂₁²−E₂(∂₂²+∂_{z}²)]u₁−(E₁−E₂)∂₁(∂₂u₂+∂_{z}u₃)=p^{1j}\hat{n}ⱼδ(z−a)

[ρ∂ₜ²−E₁∂₁²−E₂(∂₂²+∂_{z}²)]u₂−(E₁−E₂)∂₂(∂₁u₁+∂_{z}u₃)=p^{2j}\hat{n}ⱼδ(z−a) (3)

[ρ∂ₜ²−E₁∂_{z}²−E₂∇²]u₃−(E₁−E₂)∂_{z}∇·\vec{u}=P^{3j}\hat{n}ⱼδ(z−a)

The pressure distribution is assumed to be cylindrically symmetric and monotonically decreasing with radial distance from the cylindrical axis of symmetry.

This forces \vec{u} to have the form

\vec{u}(\vec{x})=uᵣ(r)\hat{r}

u_{ϕ}=0 (4)

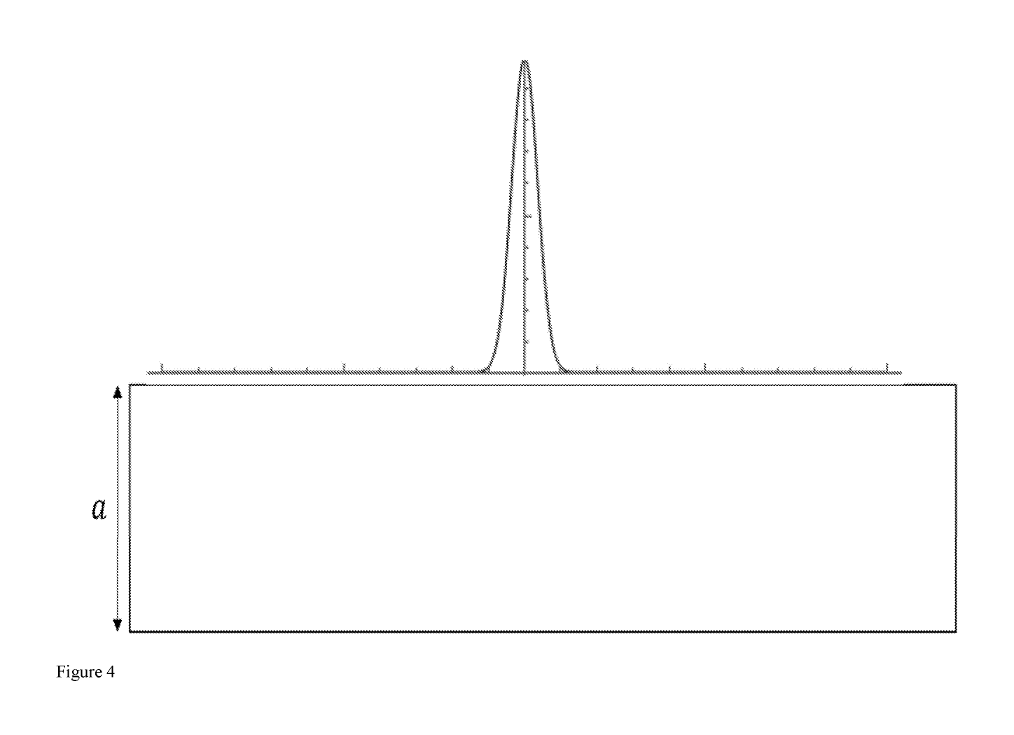

u_{z}(\vec{x})=u_{z}(r)

where r is the horizontal distance from the center of the tip to the point of interest in the sample and \hat{r} is the unit vector associated with the radial direction in cylindrical coordinates. An illustration of such a pressure distribution and the sample is given in FIG. 4.

Casting Eqs. (4) in cylindrical coordinates reduces the problem from three coupled equations to two:

[ρ∂ₜ²−E₂∂_{z}²−E₁∇²+E₁1/r²]uᵣ−(E₁−E₂)∂ᵣ∂_{z}u_{z}=Pᵣδ(z−a) (5)

[ρ∂ₜ²−E₁∂_{z}²−E₂∇²]u_{z}−(E₁−E₂)∂_{z}∇·\vec{u}=P₃δ(z−a)

The sample is subject to the boundary conditions

uᵢ(t,0,\vec{x})=0

∂_{z}uᵢ(t,a,\vec{x})=0 (6)

It is useful to express the displacement as a 2-dimensional Fourier transform and Hankel transform:

uᵢ(t,z,r)=∫dωdk∫dmαᵢ(m,ω,k)mJ_{α(i)}(mr)e^{i(kz-ωt)} (7)

where J_{c}, is the a-th Bessel function of the first kind. For i=r, a=1; for i=z, a=0.

While the Fourier transforms diagonalize the t- and z-derivatives, they do not enforce the boundary conditions. Explicitly diagonalizing the matrix operators subject to the boundary conditions is an intractable problem; however, the method of images may be employed to enforce the boundary conditions while using the Fourier transforms.

It is easier to implement the method and visualize the image source distribution by leaving the location of the real pressure distribution at z=a and setting the free boundary condition at z=a+b. Image sources are inserted above the z=a+b plane to enforce the free condition on the upper boundary; image sources are inserted below the z=0 plane to enforce the pinned condition on the lower boundary. Initially inserting the image sources to act in concert with the real source to enforce the boundary conditions generates a successive cascade of sources that must be inserted to counter the effects of each previous insertion. A visual depiction of the beginning of this cascade is given in FIG. (5). A source below the lower boundary must take the opposite sign of the source it counters; a source above the upper boundary must take the same sign as the source it counters. After the calculation is finished, b can be taken to 0.

Neglecting friction (Pᵣ=0), setting

$${P}_{z} = \frac{1}{2 π r} δ ( r ) ,$$

solving for α_{z}, performing the integrals over m and k, and setting z=a yields

$$\tilde{g} ( ω ; r ) = - \frac{ln ( 2 )}{π a μ} + ( \frac{i ω \sqrt{\frac{ρ}{λ + μ}}}{6 π ( λ + μ )} + \frac{i ω \sqrt{\frac{ρ}{μ}}}{3 πμ} ) + \frac{λ + 2 μ}{2 πμ r ( λ + μ )} + \frac{1}{4 π {a}^{3} {μρω}^{2} ( λ + μ )} \times \{ 2 {a}^{2} {μρω}^{2} ln ( 1 + {e}^{- 2 ia ω \sqrt{\frac{ρ}{λ + μ}}} ) = 2 ia μ ( λ + μ ) ( ω \sqrt{\frac{ρ}{μ}} {Li}_{2} ( - {e}^{- 2 ia \sqrt{\frac{ρ}{μ} ω}} ) - ω \sqrt{\frac{ρ}{λ + μ}} {Li}_{2} ( - {e}^{- 2 ia \sqrt{\frac{ρ}{λ + μ}} ω} ) ) - μ ( λ + μ ) ( {Li}_{3} ( - {e}^{- 2 ia \sqrt{\frac{ρ}{μ}} ω} ) - {Li}_{3} ( - {e}^{- 2 ia \sqrt{\frac{ρ}{λ + μ}} ω} ) ) \} \qquad ( 8 )$$

where Liₙ is the n-th polylogarithm, and the has been written in terms of complex Lamé parameters. Since the z-pressure was restricted to a Dirac delta at the center of the coordinate system, the resulting solution, Eq. (8), furnishes the continuous Green function for the sample in Fourier space, and thus we give the solution the variable name \tilde{g}.

This distributed surface Green function has a nontrivial action on the pressure distribution under integration, demonstrating that the spatial distribution of the force applied to the surface matters, not solely the total force. In effective approaches to AFM dynamics, such as that used in HAS-AFM, we care only about the total force acting at the sample surface, so the effective sample Green function must be some functional of the distributed surface Green function. To connect them, we must average the distributed surface Green function over an appropriate area with some particular weighting function. To determine the weighting function, we seek inspiration from known, solved problems in contact mechanics.

If an infinitely hard cylindrical probe impinges upon a sample surface, the displacement of the surface from equilibrium in the region of contact is uniform. That is,

$$\begin{matrix}{u}_{2} ( r < R ) = const . = 2 π {\int }_{0}^{R} {dr}^{′} {r}^{′} g ( r , {r}^{′} ) P ( {r}^{′} ) , \\ P ( r ) = \frac{{p}_{0}}{\sqrt{1 - {( \frac{r}{R} )}^{2}}} .\end{matrix} \qquad ( 9 )$$

Of course, beyond the contact region, the displacement is not uniform.

Since the Green function must be symmetric under r⇄r′, averaging \tilde{G}_{surface} (r,r′;ω) over r with the weighting function

$$f ( r ) = \frac{r}{{R}^{2} \sqrt{1 - {( \frac{r}{R} )}^{2}}}$$

results in a function that is independent of r′ and thus has trivial action on the pressure distribution under integration for r′<R. If our pressure distribution has a finite, effective contact radius, it is natural, and indeed necessary, to choose R such that the integral subtends exactly this contact region. Since the resulting relationship between the average surface displacement and the pressure distribution is simply the convolution of an averaged Green function with the total force, the resulting averaged Green function thus corresponds to the sample Green function in the effective models employed in HAS-AFM.

Performing the averaging yields

$${\tilde{g}}_{2}^{0} ( ω ) = \frac{λ + 2 μ}{4 μ R ( λ + μ )} - \frac{ln ( 2 )}{π a μ} + \frac{i ω \sqrt{\frac{ρ}{λ + μ}}}{6 π ( λ + μ )} + \frac{i ω \sqrt{\frac{ρ}{μ}}}{3 πμ} + \{ 2 {a}^{2} {ρω}^{2} μ ln ( 1 + {e}^{- 2 ia ω \sqrt{\frac{ρ}{λ + μ}}} ) - 2 ia μ ( π + μ ) \times [ ω \sqrt{\frac{ρ}{μ}} {Li}_{2} ( - {e}^{- 2 ia ω \sqrt{\frac{ρ}{μ}}} ) - ω \sqrt{\frac{ρ}{λ + μ}} {Li}_{2} ( - {e}^{- 2 ia ω \sqrt{\frac{ρ}{λ + μ}}} ) ] - μ ( λ + μ ) [ {Li}_{3} ( - {e}^{- 2 ia ω \sqrt{\frac{ρ}{μ}}} ) - {Li}_{3} ( - {e}^{- 2 ia ω \sqrt{\frac{ρ}{λ + μ}}} ) ] \} \qquad ( 10 )$$

Here, R is the (effective) contact radius between the tip and the sample surface. The first term is the usual contact mechanics term; the second term arises as a finite-thickness modification; the remaining terms arise from sample dynamics.

Eq. (10) is to be used in conjunction with the following equation for the cantilever's response while in contact with the sample

$${A}_{1} = {A}_{f} \vert \frac{1}{1 - Σ {\tilde{g}}_{1}^{0} ( ω )} \vert \\ {Σ}^{- 1} = {σ}^{- 1} - {\tilde{g}}_{2}^{{g}_{2}} ( ω ) \\ {\tilde{g}}_{2} ( ω ) = \frac{{\tilde{g}}_{2}^{0} ( ω )}{1 - K {\tilde{g}}_{2}^{0} ( ω )} . \qquad ( 11 )$$

where A_{f} is the cantilever's amplitude at a given driving frequency in free space, A₁ is the cantilever's amplitude at the given driving frequency while engaged with the sample, σ is simply a phenomenological parameter to fit to data, \tilde{g}₁⁰(ω) is the cantilever Green function that is calibrated before scanning, and \tilde{g}₂ (ω) is the “renormalized” sample Green function, in which K is another parameter to be fit to data. The real and imaginary parts of the parameters λ and μ, which describe the elasticity and damping of a sample, can be fit to data.

The sample thickness, a, can usually be determined by alternative means (e.g. optical measurements, or specifying the sample dimensions during fabrication); the average density, ρ, can be determined by measuring the resonance frequency if the dimensions are known or by other means. Determining these parameters are easier than estimating the tip geometry and can be much more accurately measured. Once these parameters are known, the reduced Young's modulus and damping parameters can easily be determined point-by-point while a HAS-AFM scan is being conducted by fitting the functional form to the response of the cantilever at a plurality of frequencies.

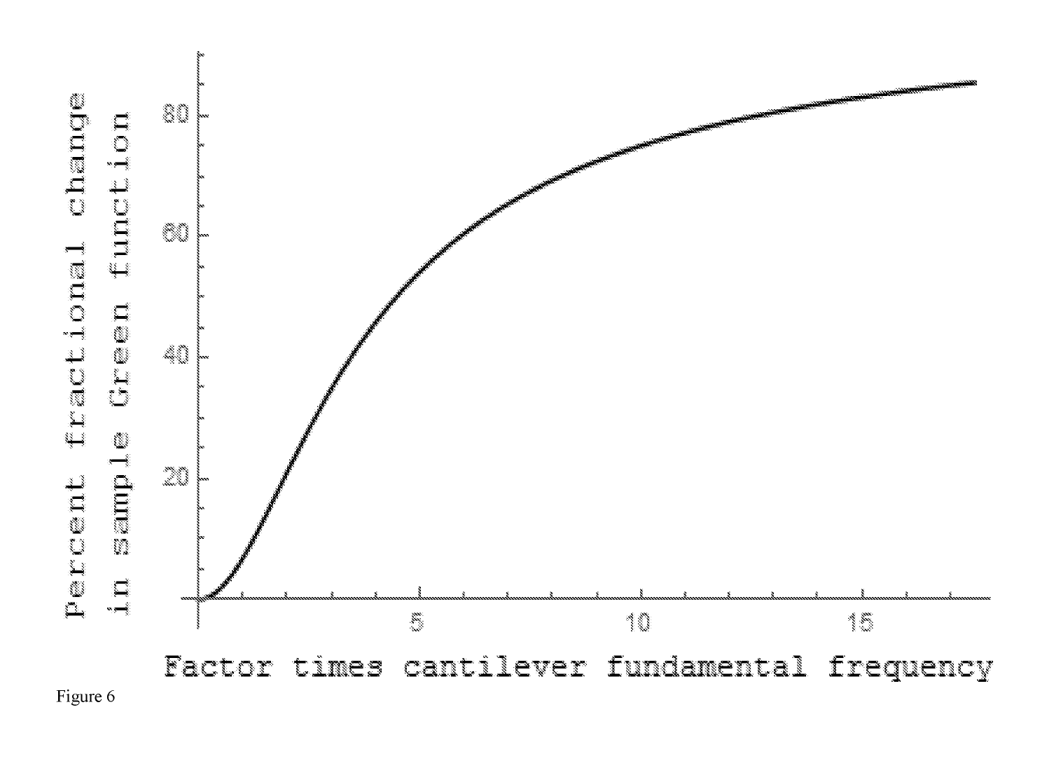

Traditional techniques that attempt to extract bulk properties of the sample consider only the first term in Eq. (10). This both incorrectly predicts the frequency dependence of that sample's response, and forces users of the technique to employ an additional technique to determine the contact radius between the tip and sample before the bulk parameters can be ascertained. This usually involves characterizing the tip geometry, which introduces a number of compounding uncertainties resulting in inaccurate bulk measurements and technical problems for the user. FIG. 6 depicts the predicted fractional change in the magnitude of the sample Green function as a function of frequency for a typical rat tail fibroblast. Interpreting the inverse of the Green function as the effective local stiffness of the cell is consistent with measurements using traditional methods.

1. A method for measuring the bulk mechanical properties of a material comprising:
employing Harmonic Amplitude Spectrum Atomic Force Microscopy to measure the response of a cantilever in an atomic force microscope system,
driving the cantilever at a plurality of frequencies and
determining mechanical properties of a sample of the material by applying a dynamic contact mechanics model to solve for bulk mechanical properties.

2. The method of claim 1 further comprising:
recording frequency and amplitude response from cantilever.

3. The method of claim 1 wherein the step of driving the cantilever includes the step of:
driving the cantilever in free space at a plurality of frequencies.

4. The method of claim 1 further comprising the step of:
engaging the sample surface with the cantilever tip.

5. The method of claim 4 further comprising the step of:
recording the cantilever response using logic on a field programmable gate array.

6. The method of claim 1 wherein the step of employing includes the step of:
providing a field programmable gate array to a signal access module on the atomic force microscope.

7. The method of claim 6 wherein the step of providing a field programmable gate array includes the step of:
recording the cantilever response using logic on the field programmable gate array.

8. The method of claim 7 wherein the step of determining mechanical properties includes the step of:
characterizing the cantilever based on the recorded response.

9. (canceled)

10. The method of claim 1 wherein the dynamic contact mechanics model includes the step of:
predicting motion of the cantilever using the model.

11. The method of claim 10 wherein the dynamic contact mechanics model includes the step of:
choosing parameters in the model of the dynamic response of the sample.

12. The method of claim 11 wherein the dynamic contact mechanics model includes the step of:
choosing parameters in the model that make the predicted motion of the model optimally fit the recorded response.

13. The method of claim 12 wherein the dynamic contact mechanics model includes the step of:
determining the contact area between the cantilever tip and sample from the fit.

14. The method of claim 13 wherein the dynamic contact mechanics model includes the step of:
extracting the reduced Young's modulus and damping parameters from the fit.

15. The method of claim 14 further comprising the step of:
using sample dynamics to determine the contact area of the cantilever tip.

16. The method of claim 14 further comprising the step of:
using sample dynamics to determine the full viscoelastic properties of the sample.
